(19) United States
(12) Patent Application Publication
(10) Pub. No.: US 2014/0095400 A1
(43) Pub. Date: Apr. 3, 2014

(54) Mobile Application for a Vendor Management System

(71) Applicants: Edward Jackson, San Mateo, CA (US); Bradley Haiar, Racine, WI (US); Peter Parks, Brookfield, WI (US); Thomas Rumberg, Brookfield, WI (US); Robert Young, Waukesha, WI (US)

(72) Inventors: Edward Jackson, San Mateo, CA (US); Bradley Haiar, Racine, WI (US); Peter Parks, Brookfield, WI (US); Thomas Rumberg, Brookfield, WI (US); Robert Young, Waukesha, WI (US)

(73) Assignee: PROVADE, INC., Milwaukee, WI (US)

(21) Appl. No.: 14/027,945

(22) Filed: Sep. 16, 2013

Related U.S. Application Data
(60) Provisional application No. 61/701,472, filed on Sep. 14, 2012.

(51) Int. Cl. G06Q 10/10

(52) U.S. Cl. CPC G06Q 10/1053
USPC 705/321

(57) ABSTRACT

The present invention generally relates to a mobile vendor management software application and system or (“VMS”) system that allow users to better manage the procurement and management of outside sources of labor. The software application may be resident on a mobile device and allows a user of the mobile device to communicate with a VMS system or database in order to perform traditional VMS functions. The mobile VMS application may also allow for additional functionality by integration of various functions and features available on the mobile device into the software application.

### CROSS-REFERENCE TO RELATED APPLICATIONS

This application claims the benefit of U.S. Provisional Application No. 61/701,472, filed Sep. 14, 2012, which application is hereby incorporated herein by reference, in its entirety.

### FIELD OF INVENTION

The present invention generally relates to a mobile vendor management software system or (“VMS”) system that allows users to better manage the procurement and management of outside sources of labor by leveraging all the functions of a traditional VMS and enhancing them by incorporating key functionality of a smart phone or mobile device.

### BACKGROUND OF THE INVENTION

Vendor Management System software (“VMS”) is a tool for procuring and managing outside sources of labor, including temporary employees, independent contractors, and professional service firms. VMS performs a range of functions, including order or requisition distribution and response processes, resumé submission and review processes, hiring and on-boarding processes, timesheets and expenses submission and approval processes, invoicing, payment, budget management, performance evaluations of suppliers and workers, and analytics regarding all of the above.

VMS is typically web-based, and is often provided as Software as a Service (SaaS) that requires a personal computer or laptop and web browser for access and full functionality.

Some VMS providers have developed limited mobile functionality by creating a mobile-friendly limited version of their VMS that is accessible through a web browser on a mobile device. In addition, some have developed mobile device applications such as timecard functionality for Android and iPhone mobile devices. There is currently no VMS that provides BlackBerry® functionality, nor any VMS that provides full end-to-end functionality through mobile applications.

Thus, there remains a need for an application that allows VMS to be fully run on a mobile device, and that integrates VMS capabilities with the unique functionality mobile devices or smart phones offer.

### SUMMARY OF THE INVENTION

Briefly stated, the present invention is a software application and system for running a VMS on a mobile device and leveraging key features of a mobile device to enhance the functionality of a VMS. Historically, VMS software has been limited to computer applications, that is, systems that must be run on traditional desktop computers or laptops. However, in recent years, the prevalence and technological advancement of mobile devices such as smart phones and tablets has created a need for the ability to run many traditional software programs on such mobile devices, with software specifically tailored for such mobile devices, that also integrates the additional functionality that mobile devices offer. Within the realm of mobile devices, these specifically tailored software programs are typically referred to as “apps.” The present invention provides a mobile VMS app which provides the full functionality of a VMS system, while seamlessly integrating it with the added functionality of a mobile device.

The present invention may be designed to work with current popular mobile operating systems such as Android™, BlackBerry®, and iPhone® platforms.

In general, the mobile VMS application allows users (such as customers, workers, managed service providers (MSP), and suppliers) to perform all of the functions that are traditionally available on a desktop VMS system. Each application may include a shared set of general functions, such as the ability to setup a unique passcode, the ability to designate a proxy or set up an alternate approver, provide a method for contacting the VMS provider, and a news feed within the app that is specific to the contingent labor program the user is participating in. The mobile VMS application will also have appropriate security features, including, at a basic level, user name and password functionality. Once registered within the mobile VMS application, a user may search for jobs within the application, and simply click to submit his or her resumé, reply to job postings, and perform many other job related tasks.

In addition to the features currently available to registered VMS users, the mobile VMS application will allow for user self-registration, so users can create a profile in order to submit their resumés for job postings they see on LinkedIn® or elsewhere.

As with any VMS system, a data connection to at least one server/database is necessary to download and upload data. Because the mobile VMS application is designed to work on mobile devices, the invention may take advantage of cellular, wireless, or even wired communications mediums to establish such a data connection. In consideration of the data usage limitations instituted by various communications providers, the mobile VMS application also offers an offline/plane mode that takes a static picture of the database and stores it on the device for a user to continue usage of the VMS system during travel. When Wi-Fi or mobile access is restored, the database will sync with the server/database and complete the transactions that were initiated in offline/plane mode.

The data that is downloaded to the device is specific to the role of the user and the permissions the user would have in the traditional VMS setting. A user of the mobile VMS application may open the application on a mobile device and see a dashboard of items relevant to that particular user, including tasks, announcements, messages, reminders, calendar, and available workflows. The user may then click on the available workflows link and will see all of the actions they are able to take.

The present invention may be embodied in four different apps that work together to create the full end-to-end VMS functionality available on a desktop or laptop computer. Each app may be tailored to the specific functions of each user of a traditional VMS system, including: customer, worker, managed service provider (MSP), and supplier. Each application will also leverage the features of the mobile device in complementary ways to enhance the function for each specific function.

In the customer version of the mobile VMS application, the application may provide timesheet approval or denial, expenses approval or denial, budget management, reports (headcount, spend, start dates, end dates, tenure, fill rates, performance), work order routing and approval, requisition routing and approval, creating and distributing requisitions, resumé review, interview initiation, interview scheduling, invoice review and approval, communicating with other managers regarding resumés, and alerts when new e-mails requests or reminders are received.

Mobile device or smart phone features may be leveraged to provide additional functionality in the customer version of the app, including: calendar integration to request and schedule candidate interviews, set reminders for time sheet and expense approval, short messaging service (SMS) messaging to send out reminders to candidates or suppliers, telephone integration to provide one-click calling of candidates or suppliers, and video camera/video chat integration for video interviews of candidates.

In the worker version of the mobile VMS application, the application may provide functionality related to: resumé submission, interview requests, interview scheduling, pre-employment document submission, scheduling of pre-employment testing or screening, timesheet submission, expenses submission, contact information update, alerts, and reminders.

Mobile device or smart phone features may be leveraged to provide additional functionality in the worker version of the app, including: video camera/video chat integration for video interviews; camera integration for submitting copies of employment documents, such as driver's license, or expenses documentation, such as photographs of receipts from restaurants or hotels; LinkedIn® integration to review the profile of the interviewer or search for jobs outside of the app; map and global positioning satellite (GPS) integration to provide directions from home to the interview location or pre-employment screening locations, such as for drug testing, and to estimate the cost of commuting to a position; security features and touch screen integration for signing documents with finger or stylus and submitting them through e-mail or directly within the app, such as right to represent documents, employment applications, consents to background testing, EFT authorization, timesheets, and expenses; SMS integration for notices from MSP, suppliers, or the customer regarding timesheet deadlines, changes in schedule, and the like; integration with the contacts functionality to maintain relevant information for MSP, suppliers, and workers; integration with the contacts functionality to maintain relevant information for customers, MSP, and supplier; one click phone dialing; and integration with calendar to schedule interviews, drug screens, first day of work, leave days, and other relevant dates.

In the MSP version of the mobile VMS application, the application may provide functionality related to: supplier management, invoicing, budget management, reports, resumé review, resumé submission, interview initiation, pre-employment requirements initiation, sharing information with other managers, reminders and alerts, tasks, supplier performance reports, rate reports, comparisons in program vs. local rates, and all reports the customer has.

Mobile device or smart phone features may be leveraged to provide additional functionality in the MSP version of the app, including: video camera/video chat integration for video interviews of candidates or suppliers, or to have customer meetings; camera integration for submitting expense records, such as receipts from restaurants or hotels; LinkedIn® integration for reviewing candidate profiles or providing interviewer profiles to candidates; calendar integration to schedule interviews or pre-employment screening tasks; SMS integration to send out reminders; integration with the contacts functionality to maintain relevant information for customers, suppliers, and workers; and one click phone dialing.

In the supplier version of the mobile VMS application, the application may provide functionality related to: requisition review, resumé submission, interview confirmation, timesheet records, expense records, invoicing, proxies to enter time or expenses on behalf of workers, alerts and notifications, submission of contracts or other required documents, and reminders of when certain contractual events occur, such as tenure discounts.

Mobile device or smart phone features may be leveraged to provide additional functionality in the supplier version of the app, including: video camera/video chat integration for video interviews of candidates or suppliers, or to have customer meetings; camera integration for submitting expense records, such as receipts from restaurants or hotels; LinkedIn integration for reviewing candidate profiles or providing interviewer profiles to candidates; calendar integration to schedule interviews or pre-employment screening tasks; SMS integration to send our reminders; integration with the contacts functionality to maintain relevant information for customers, MSP, and workers; one click phone dialing; e-mail integration to send in insurance certifications and other documents; and touch screen integration for signing contracts and purchase orders.

The present invention may also allow the management of services that are provided pursuant to a statement of work.

The mobile VMS application may be designed to provide a single point of data entry for on-boarding an individual who is hired. Once the hire is approved, a series of e-mails, SMS messages, and calendar appointments and alerts may be sent to all departments who have an on-boarding task, e.g., IT to build a new computer, HR to initiate paperwork, and to security to initiate background check and badging.

The mobile VMS application may also provide an “in-app” advertising service for suppliers to highlight the skill sets, services, and candidates they are offering. Likewise, customers could use the service to highlight open positions. The advertising service may allow for suppliers to purchase ad placement within the mobile VMS application, with additional options for better (i.e., more visible) ad placement, more text, or bolder text. The mobile VMS application may also provide an in-app news ticker for MSP (or customer) to provide information regarding the program.

The present invention may provide marketplace functionality that matches job seekers with open job postings, and have various social media programs integrated into the mobile VMS application for direct interaction with the social media programs. Examples of social media support include: LinkedIn®, Facebook®, and Twitter®. For instance, the mobile VMS application may be able to have a person's LinkedIn® profile linked directly to the person's internal profile within the mobile VMS application. This may allow for profile/resumé review for candidates, and profile review for interviewers. It would also allow customers or MSPs to post jobs internally or externally.

The basic structure or architecture of the app is a distributed front end that users would interact with attached to a database that holds the information accessed through the front end. The mobile VMS application is “n tier”, meaning it has a variable number of tiers and can either be standalone, as described above, or integrated with various backend products, such as an existing VMS system or other applications. The mobile VMS application may further provide a contacts functionality in order to maintain a contacts lists of pertinent contacts such as applicants, interviewers, suppliers, or other contacts. A click-to-call phone function provided by the mobile VMS application allows a user to immediately call a contact within the contact list without needing to otherwise exit the mobile VMS application, or use an external calling device.

The examples set out in this Summary provide a sample of the various capabilities offered by the mobile VMS application, and are not intended to limit the breadth or functionality of embodiments of the invention. These and other aspects of the invention will become clear in the following description.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram exemplifying the basic architecture of the present invention;

FIG. 2 is a drawing exemplifying a login screen for a mobile VMS app;

FIG. 3 is a drawing of a new password screen for a mobile VMS app;

FIG. 4 is a drawing of a home screen for a mobile VMS app;

FIG. 5 is a drawing of a settings screen for a mobile VMS app;

FIG. 6 is a drawing of an e-mail screen for a mobile VMS app;

FIG. 7 is a drawing of an alerts screen for a mobile VMS app;

FIG. 8 is a drawing of an approvals screen for a mobile VMS app;

FIG. 9 is a drawing of a back button screen for a mobile VMS app;

FIGS. 10A and 10B are drawings exemplifying portrait and landscape views, respectively, of an expense approvals screen for a mobile VMS app;

FIGS. 11A and 11B are drawings exemplifying portrait and landscape views, respectively, of an expenses screen for a mobile VMS app;

FIGS. 12A and 12B are drawings exemplifying portrait and landscape views, respectively, of a deny expenses screen for a mobile VMS app;

FIGS. 13A and 13B are drawings exemplifying portrait and landscape views, respectively, of an expenses entry screen for a mobile VMS app;

FIGS. 14A and 14B are drawings exemplifying portrait and landscape views, respectively, of a progress log screen for a mobile VMS app;

FIGS. 15A and 15B are drawings exemplifying portrait and landscape views, respectively, of a progress log approval screen for a mobile VMS app;

FIGS. 16A through 16F are several drawings exemplifying progress log screens for a mobile VMS app;

FIG. 17 is a drawing of a requisitions screen for a mobile VMS app; and

FIG. 18 is a drawing of an assignments screen for a mobile VMS app.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

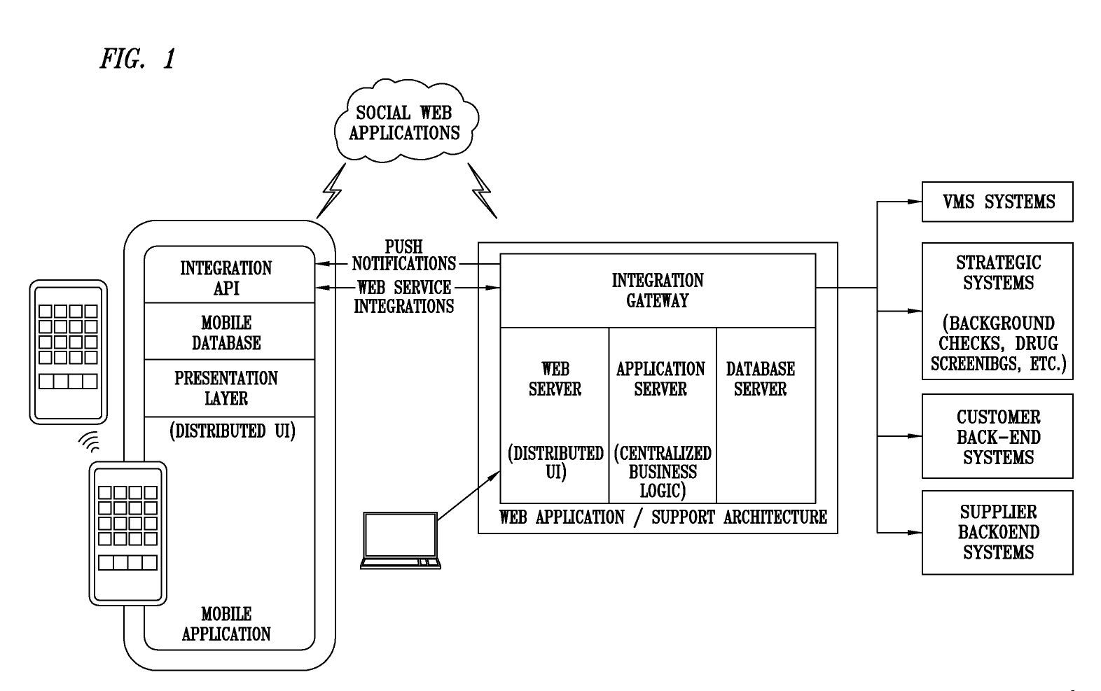

Referring to FIG. 1, a diagram of a mobile VMS system is shown. The VMS system includes mobile devices such as cellular phones or tablets, the mobile VMS application resident on the mobile devices, an integration gateway, and VMS servers and databases. The mobile devices and mobile VMS applications provide for communication between a user and the integration gateway, and may comprise a data or communications connection between the two. The integration gateway may further comprise web servers, application servers, and database servers. Other devices may also be supported by and are communicably connected to the integration gateway, for instance, traditional desktop or laptop computers which may utilize a web browser to access the integration gateway.

The mobile VMS application is comprised of an integration application programming interface (API), mobile database, and a presentation later. The integration API allows for access to functionality resident within the mobile device, such as email, calendar, tasks, contacts, and third party apps. Hardware features such as cameras, microphone and speakers, and GPS radios may also be accessed by the mobile VMS application via the integration API. The mobile database provides for storage of VMS related data and allows a user to access the locally stored information even when the mobile device is offline from the integration gateway and VMS servers and databases. The presentation layer of the mobile VMS application provides for the overall “look and feel” of the application to the user. That is, the graphical user interface and other interactions with the user of the application are controlled by the presentation layer of the mobile VMS application. Together, these three components of the mobile VMS application provide for the overall experience of the user.

Third party websites, such as social media websites LinkedIn®, Twitter®, and Facebook® may also be accessed by the mobile devices and traditional computers, with social media functionality built into the mobile VMS application.

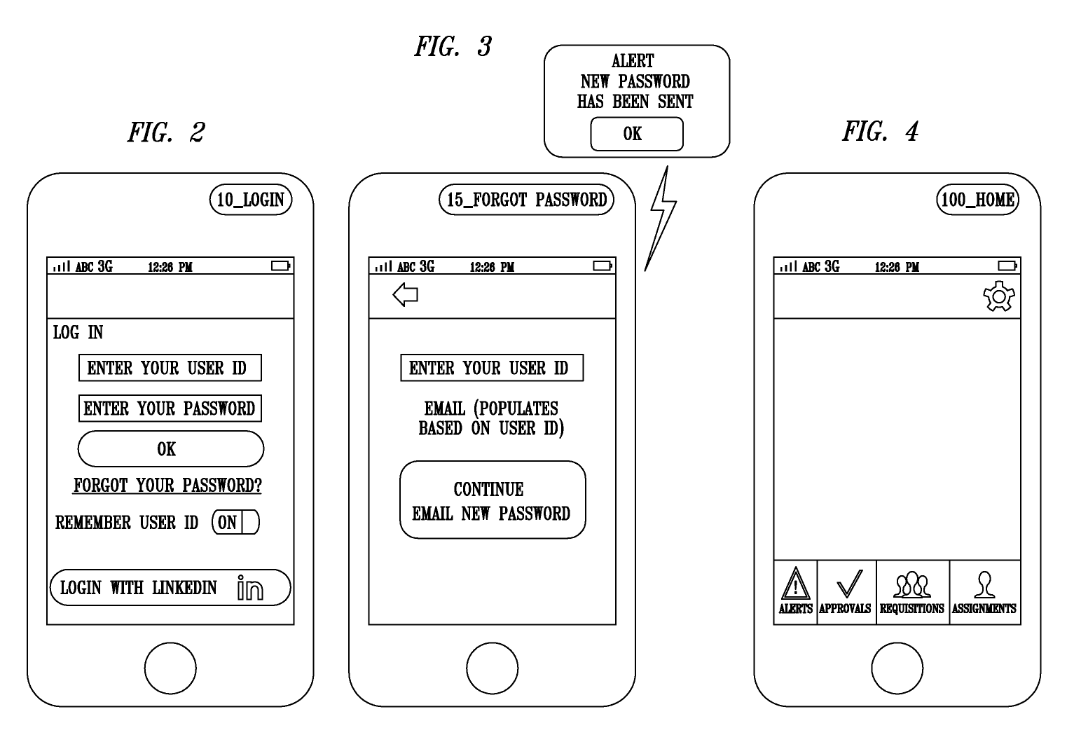

Turning to FIGS. 2 and 3, a login screen of the mobile VMS application is shown on a mobile device, such as an Apple® iPhone® or iPad®. The mobile VMS application may be implemented for use on other mobile devices with internet or network connectivity. A user of the VMS system may interact via user interface implementations of the mobile device. The login screen has inputs for a user id, a password, and a password retrieval function in the event a user loses or cannot remember the password. An alternative login function may also be present on the login screen, which provides login functionality and allows a user to login to the mobile VMS application via other authentication or verification methods such as through the social network Linkedin.com, or Facebook.com. In the embodiment of the mobile VMS application, certain viewable screens of the application may be designed to switch from portrait to landscape presentation of the screen depending on the current orientation of the mobile device being utilized by a user. Such functionality is optional, and has no adverse impact on the functionality of the application.

A “forgot your password?” screen is shown for users who cannot remember the appropriate password for a given user id. Forgot your password screen may be accessed from the login screen via the password retrieval function, and the user may enter a user ID in the user ID field. Through interactions within this screen, the user may have a temporary password sent to an email address associated with the user ID. An alert will pop up on the forgot your password screen to indicate that the temporary password has been sent. After receiving the temporary password, the user may then return to the login screen to again attempt to login to the mobile VMS application.

Turning now to FIG. 4, a home screen of the mobile VMS application is shown. By using a menu button or other suitably assigned or programmed button or interactivity option (such as swiping) available on the mobile device, a user may bring up a series of default menu items which may be accessible within the mobile VMS application regardless of which screen the user is currently located. The menu items may comprise a home button, an alerts button, a time button, and an expense button. Each of these respective buttons allows a user to access the various aspects of the mobile VMS application.

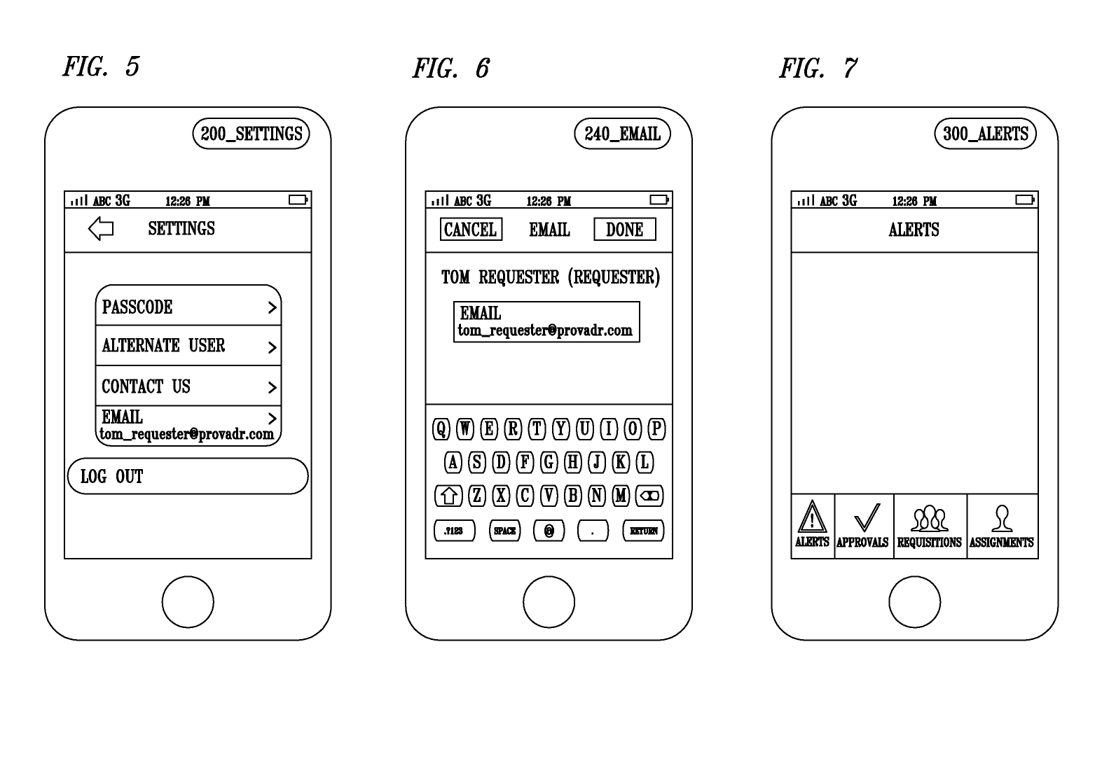

At FIG. 5, a settings screen of the mobile VMS application is shown. The settings screen contains various settings options for the mobile VMS application, and allows a user to adjust the settings via subscreen options such as passcode settings, alternate user settings, and email settings. Additionally, the settings screen may further include a link to a contact subscreen wherein contact information for the provider of the mobile VMS application may be displayed. Additionally, the settings screen may further provide a logout option for a user to securely log out of the mobile VMS application.

Continuing to FIG. 6, a representative email screen of the mobile VMS application is shown. The email screen shown allows a user to compose a new email to a mail recipient, and may utilize the contacts list already available within the mobile device. Typically, a user will have various other email applications within the mobile device, however, the email functionality provided within the mobile VMS application allows for the user to continue performing all VMS related functions within the VMS application without having to open up yet another application. The email functionality provided further allows receiving and reading emails as well as other standard email capabilities (not shown).

Next at FIG. 7, an alerts screen is shown, which is one of the items accessible from the main menu shown on FIG. 4. Within the alerts screen, various alerts, whether preset by the user or by other functions within the VMS system may be displayed. The alerts screen may also automatically pop-up alerts as they occur without the necessity of the user accessing the screen manually. Alerts may also utilize other feedback available within the mobile device, such as sound and vibration to provide audible and haptic feedback to the user in addition to visual alerts. In this manner, the user will be notified of critical events via the alert screen immediately, rather than the next instance when the user checks the alerts.

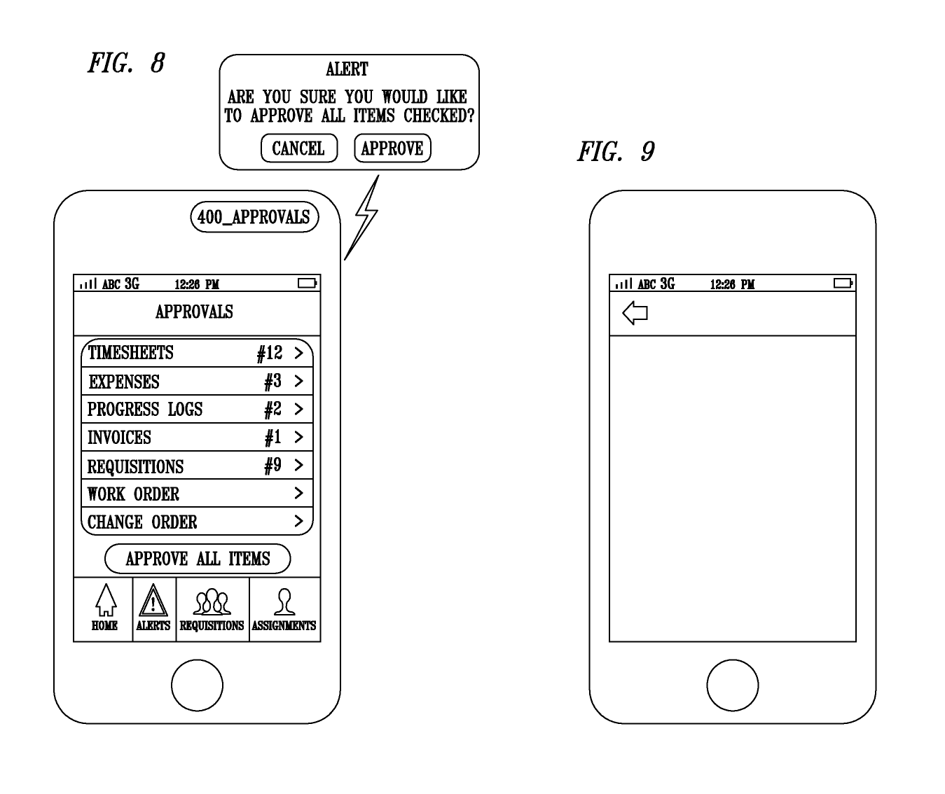

In FIG. 8, an approvals screen of the mobile VMS application is shown. The approvals screen contains a number of items for which a user may provide approval or authorization. Such items may include, but are not limited to: timesheets, expenses, progress logs, invoices, requisitions, work orders, and change orders. The user may individually select an item to review more details regarding a particular item. Furthermore, the mobile VMS application may intuitively provide the number of each of the respective approval types, and may also allow for sorting of the type of approvals depending on various attributes of the approval types. Within the approvals screen, the user may also select or check a box next to each item that he or she wishes to approve. Then, after all desired approvals are selected, the user may approve all items at once using an “approve all items” button. An alert would confirm the user's command to approve all selected items. Should the user wish to reset the items for approval, a cancel button may be provided for that purpose.

Next at FIG. 9, a back button screen is shown. The back button provides for a way to allow a user to return to a previously displayed screen of the mobile VMS application. Within the mobile VMS application, the back button may be selectively placed to provide the user with maximize ease of navigation within the various menus. Furthermore, should the mobile device already support a physical back button, the physical back button may provide substantially the same functionality as the back button shown in FIG. 9.

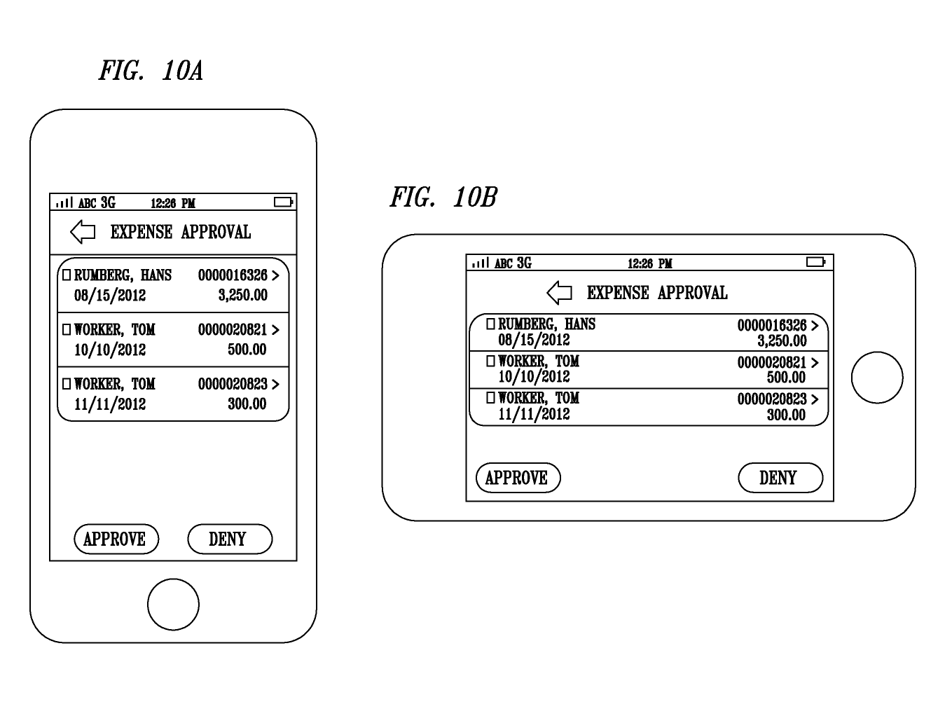

Continuing to FIGS. 10A and 10B, an expense approval screen for the mobile VMS application is shown. Referring briefly back to FIG. 8, should a user click on the “expenses” button shown, the user will be directed to the expense approval screen shown in FIGS. 10A and 10B. Within the expense approval screen, the user may be able to see a list of all expenses which require approvals, along with additional details of each individual or itemized expense. As with the general approvals screen shown in FIG. 8, the user may be able to manually select individual items for approval by checking a box next to each item. After all desired approvals have been selected, the user may then approve all expenses at once by clicking the “approve” button. Alternatively, the user may instead desire to deny all selected expense approvals, in which case, the user would simply select the “deny” button.

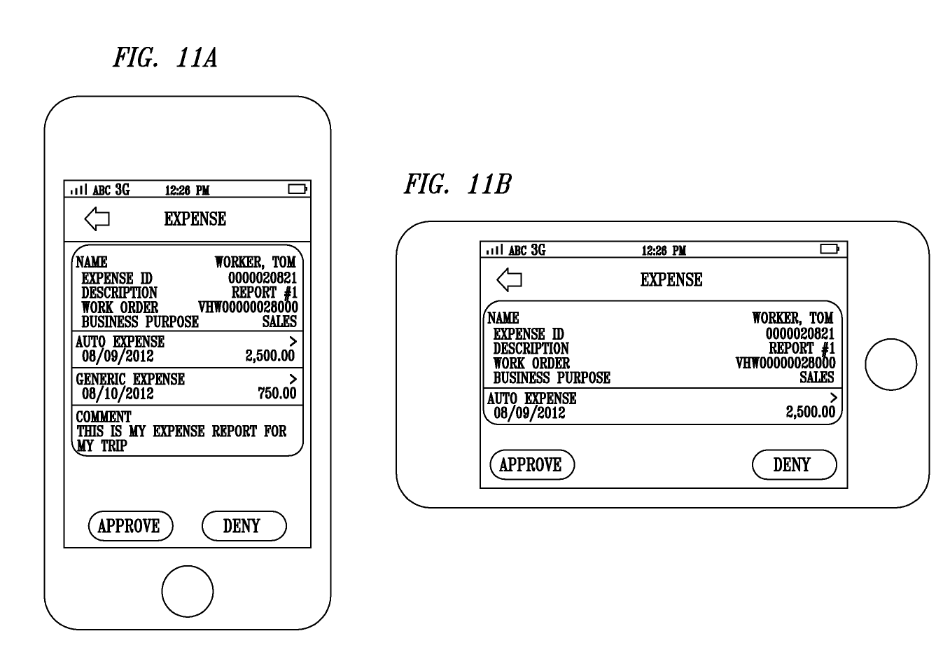

In FIGS. 11A and 11B, an expense screen is shown, which illustrates an individual itemized expense. The expense screen of FIGS. 11A and 11B is accessed by selecting an individual expense item from the list of items provided, for example, in FIGS. 10A and 10B. Here, the user is able to view all pertinent details for a particular expense, including: name of the person submitting the expense, an expense ID number, a description concerning the expense, the purpose of the expense, the amount of the expense, and any additional comments by the submitting person.

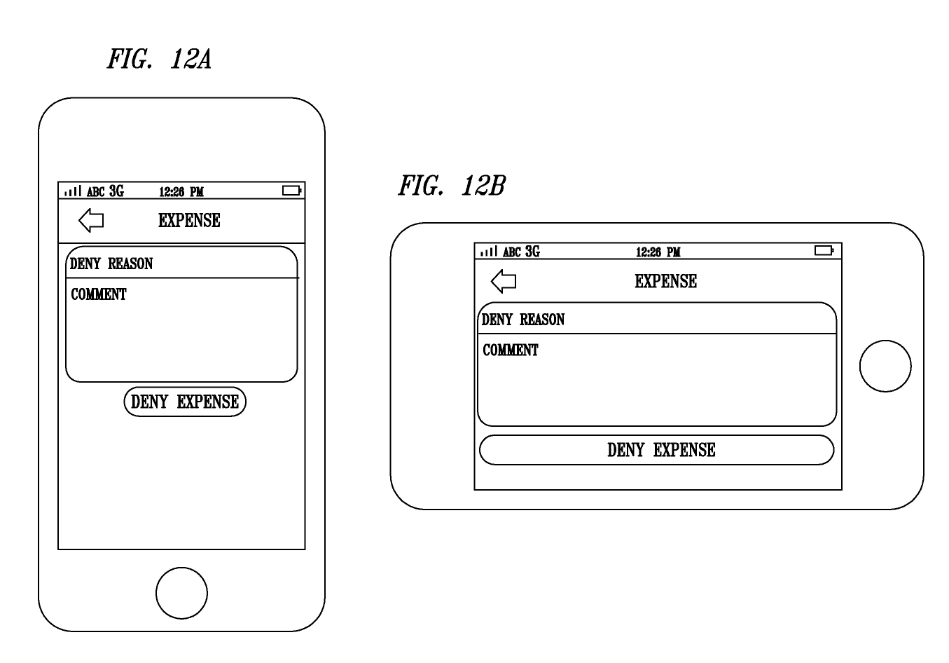

Continuing to FIGS. 12A and 12B, a deny expense screen is shown. The deny expense screen is shown whenever a user elects to deny an expense approval item. The deny expense screen thus provides an opportunity to confirm the denial of an expense as well as for a user to provide specific comments as to the denial of the expense. The denial and any optional comments are then uploaded to the VMS system where it may be accessed or viewed by other users of the mobile VMS application.

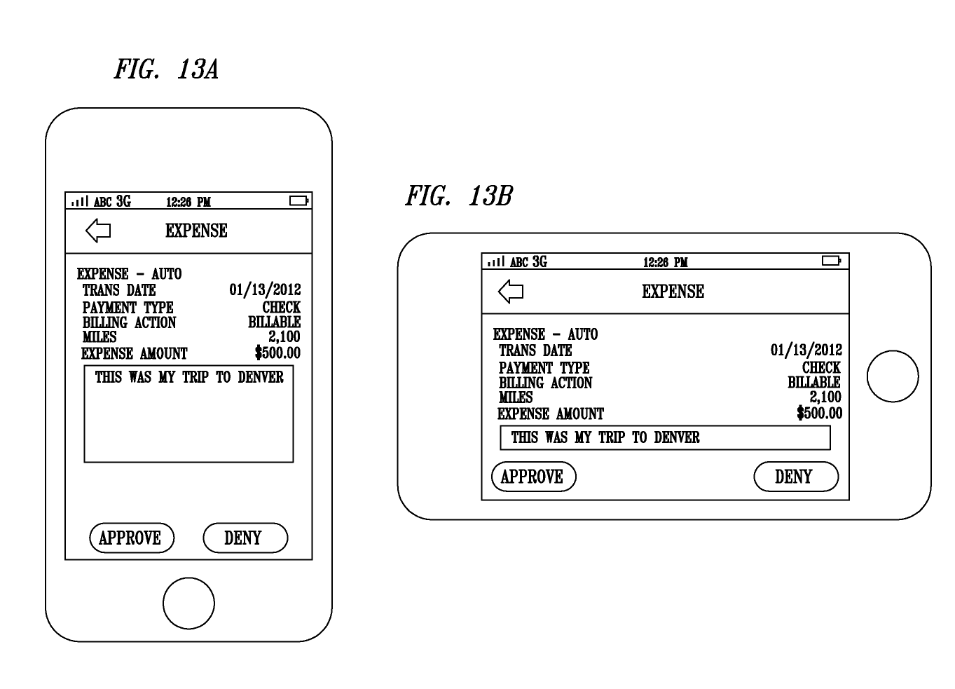

In FIGS. 13A and 13B, therein is shown an expense entry screen. The expense entry screen allows a user to enter an expense which would require approval before payment of the expense. The expense entry process may include entering the transaction date, payment type, billing status, expense amount, as well as providing for a comments section for the person submitting the expense to add notes or comments. After entry of the expense, the information would be uploaded to the VMS server or database, and another user of the mobile VMS application would be able to view the expense immediately.

It can be seen from the various expense related screens shown in FIGS. 10A-13B that the mobile VMS application provides for a streamlined and intuitive system and method for entering, reviewing, approving, and/or denying expenses. The application thus provides for a conveniently accessible expense management functionality regardless of the user's present location. That is, so long as a user's mobile device has connectivity to an appropriate network, such as the internet, he or she may be able to manage expenses even while away from the home or office.

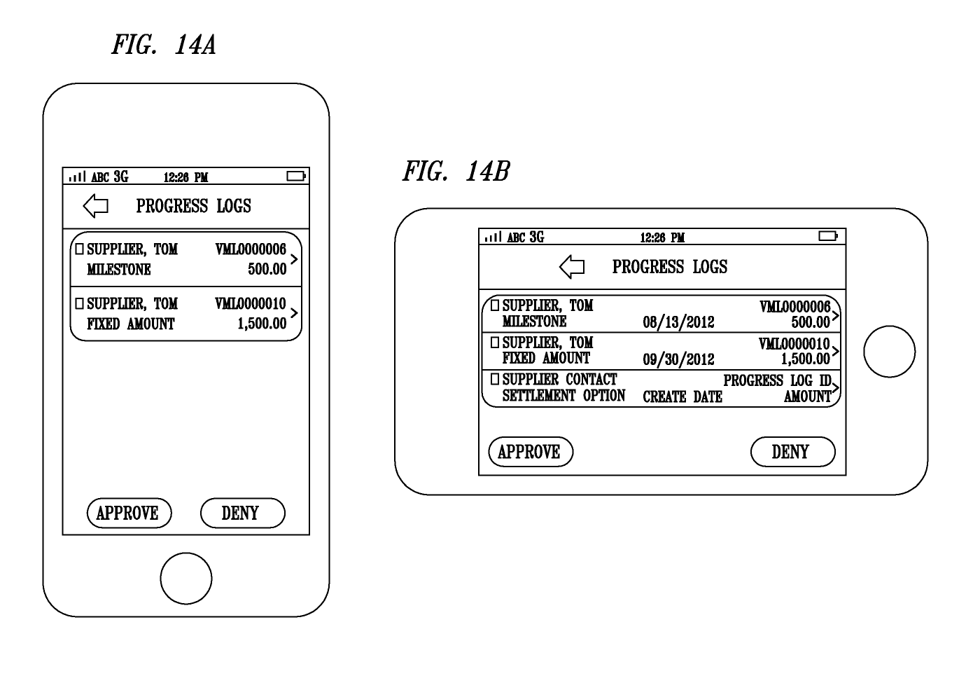

FIGS. 14A and 14B illustrate a progress logs screen of the mobile VMS application. The progress logs screen may be accessed via the approvals screen shown in FIG. 8. Much like the expense screens of FIGS. 10A-13B, the progress logs screen provides a list of progress logs awaiting user review and approval. That is, progress logs may be sorted and listed on the screen of the mobile device depending on various attributes of the individual itemized progress logs. As with expenses, a user may be able to check a box next to each progress logs item within the list, and then batch approve or deny all the selected progress logs with the click of a button. Similarly, the user may decide to clear all selected items and begin anew in checking items.

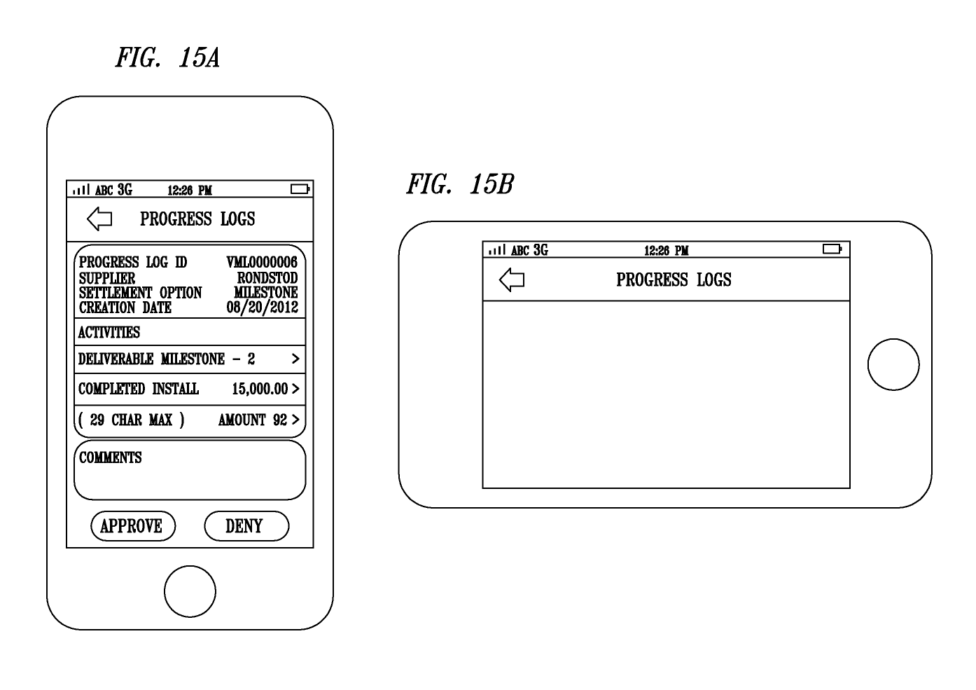

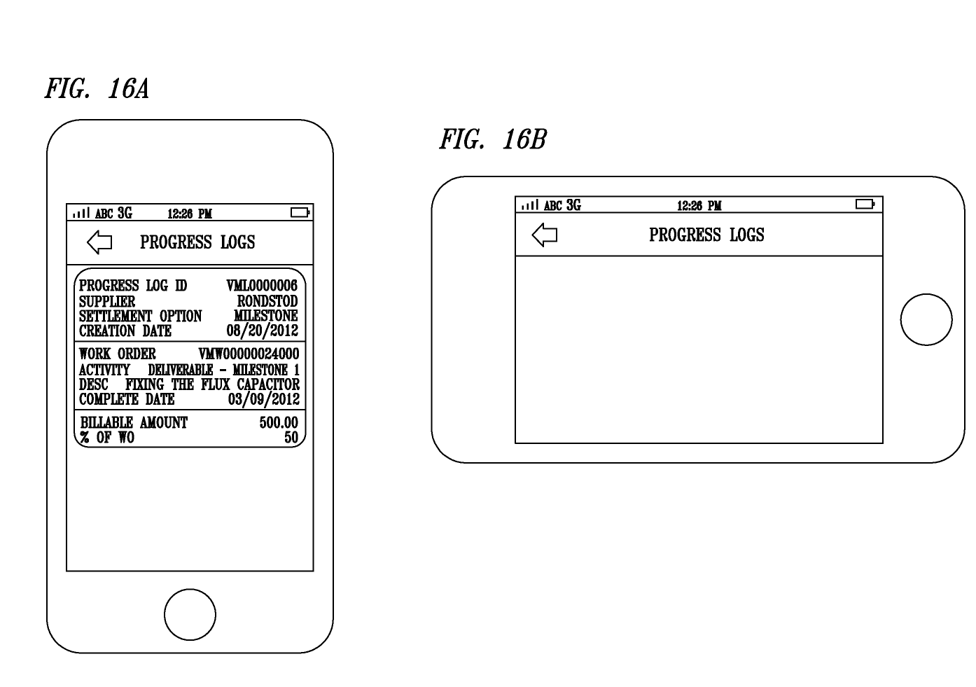

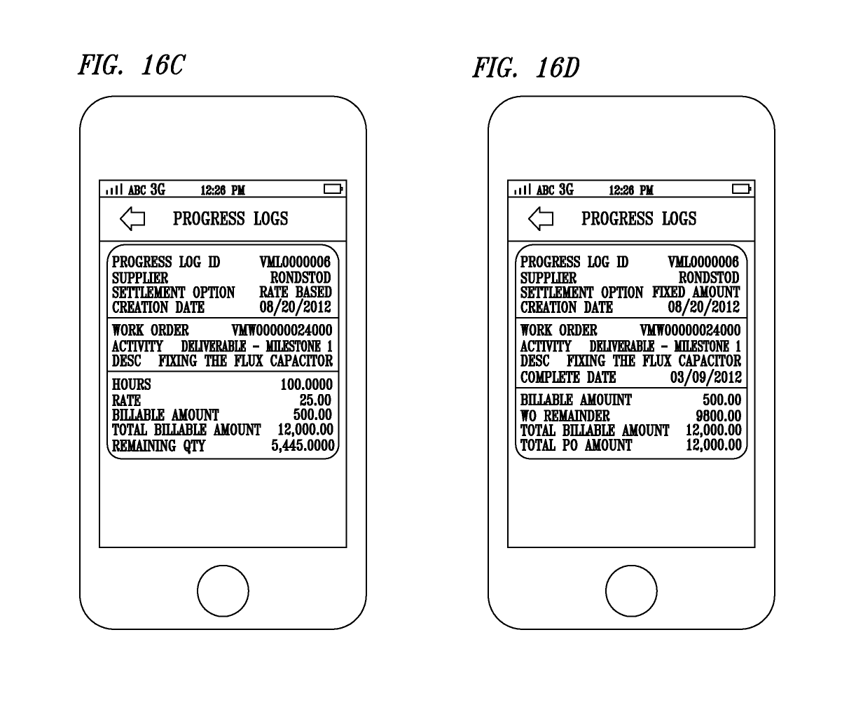

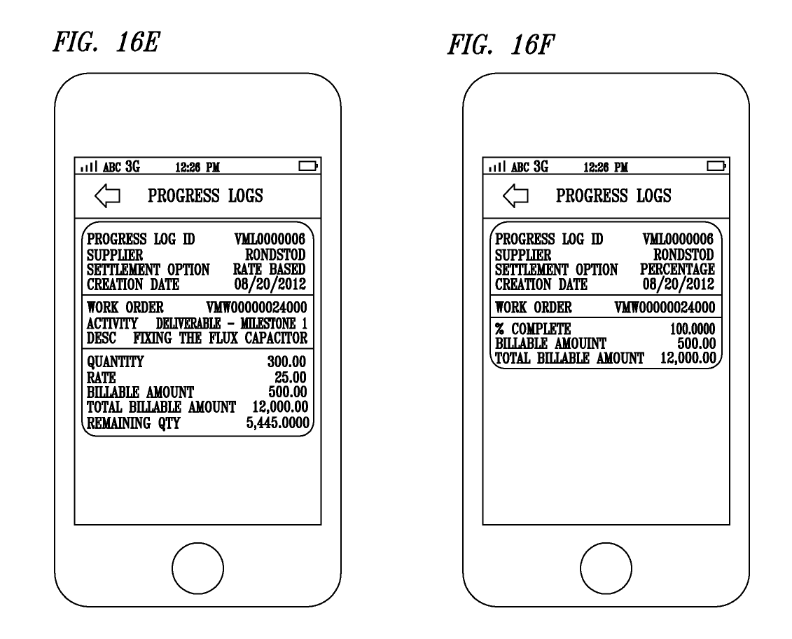

FIGS. 15A and 15B and 16A through 16F illustrate various progress logs screens that display detailed information of each progress logs item shown in FIGS. 14A and 14B. The detailed view of the progress logs screen may contain information such as: progress log ID number, supplier information, settlement option, creation date, activities, deliverables, completed install, as well as a comments section. Other information that may be entered in the progress logs screens shown in FIGS. 15A, 15B, and 16A through 16F include: hours, rates, quantity, billable amount, etc. After entry and submission of the progress log information, the progress log is uploaded to the VMS server or database whereby another user of the mobile VMS application may be able to view the entered progress logs, and enter approvals or denials for the progress logs.

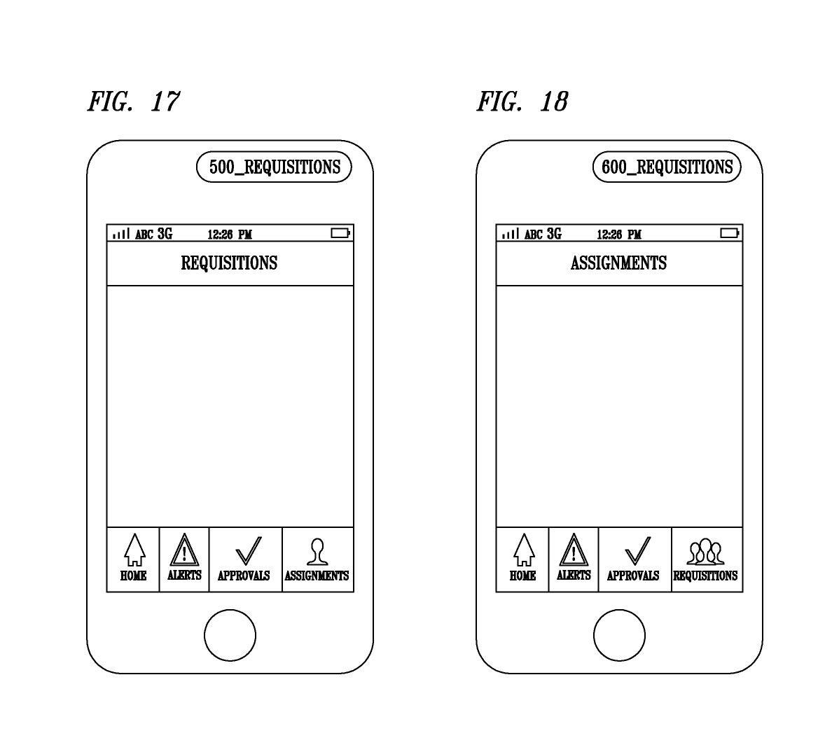

FIG. 17 illustrates a requisitions screen of the mobile VMS application, wherein requisitions and related functions may be displayed. Requisitions are requests sent by customers to MSPs or suppliers to fill open positions by submitting candidates. The requisitions screen may be developed to show open requisitions; a button or link to initiate a new requisition; a button or link to a means of distributing a requisition through SMS message, e-mail, or internally within the app; a button or link to create an internal ad to promote the requisition; a list of recently closed requisitions; and other relevant data or functions.

FIG. 18 illustrates an assignments screen of the mobile VMS application, wherein assignments may be displayed. Assignments (or engagements) are descriptions of the temporary positions requisitions are issued to fill. They can also refer to the term of a worker's engagement on a project or in a position. This screen may be developed to display the details of duties attendant to the assignment, the worker who is performing the assignment, the billing rate or pay rate for the assignment, expected length of the assignment and regular hours of work, the customer's manager who is in charge of the assignment, the worksite location, any additional equipment or clothing required, and other relevant information.

Thus, the various screens described above illustrate a portion of the functionality of the mobile VMS application; however, other embodiments of the application may support additional functionality typically present within computer based VMS systems. The mobile VMS application may also work as a standalone application, or in conjunction with presently existing VMS systems, and would be able to communicate with VMS servers and databases which are already available. Thus, integration of the additional mobile devices supporting the mobile VMS application may be seamless and allows users convenient access to the VMS system whenever and wherever there is a need for management of outside labor. Furthermore, the additional functionality typically provided by a mobile device, such as contacts lists, GPS, cellular connectivity, and voice connectivity allows the mobile VMS application to provide functionality not available with current VMS implementations.

It will be readily apparent to those skilled in the art that the general principles defined herein may be applied to other embodiments and applications without departing from the spirit and scope of the present invention. Having thus described the exemplary embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments.

1. Mobile vendor management software system comprising:
a mobile device having at least a processor and a memory effective for storing software instructions executable by the processor;
vendor management software (VMS) application stored in the memory, the VMS being configured for allowing users to better manage the procurement and management of outside sources of labor; and
an antenna coupled to the processor for communicating with a VMS system or database to perform traditional VMS functions.
